(19) United States
(12) Patent Application Publication
(10) Pub. No.: US 2017/0304830 A1
(43) Pub. Date: Oct. 26, 2017

(54) SPIDER BUSHING ASSEMBLY FOR A GYRATORY CRUSHER

(71) Applicant: Metso Minerals Industries, Inc., Waukesha, WI (US)

(72) Inventor: Donald J. Polinski, Houston, TX (US)

(73) Assignee: Metso Minerals Industries, Inc., Waukesha, WI (US)

(21) Appl. No.: 15/137,527

(22) Filed: Apr. 25, 2016

(51) Int. Cl. B02C 2/06

(52) U.S. Cl. CPC B02C 2/06

(57) ABSTRACT

A gyratory crusher and a spider bushing assembly for supporting a spider bushing within the central hub of a gyratory crusher. The spider bushing assembly includes a spider bushing and a means for adjusting the distance between the outer flange of the spider bushing and a support shoulder formed within the central hub of the spider. The means for adjusting allows the position of the spider bushing within the internal bore of the central hub to change while maintaining an interference fit as a result of wear following use of the gyratory crusher. In one embodiment, one or more annular shims are positioned between the bearing support shoulder of the central hub and the outer flange of the spider bushing. Upon wear, one or more of the shims can be removed to improve the interference fit between the spider bushing and the internal bore formed within the central hub.

### BACKGROUND

The present disclosure generally relates to a spider bushing for use within a gyratory crusher. More specifically, the present disclosure relates to a system and method for adjusting the position of a spider bushing within a spider of a gyratory crusher to selectively modify the interference fit between the spider bushing and an internal receiving bore within the central hub of the spider.

Presently, gyratory crushers exist that include a cast iron spider bushing that is installed within the internal bore formed in the central hub of the spider with an interference fit. The internal bore of the spider hub is machined with a tapered inside diameter (ID) and the spider bushing is machined with a tapered outside diameter (OD). The spider bushing is formed with an outer flange having a series of spaced through holes such that bolts can be used to pull the tapered spider bushing down tightly into the internal bore of the spider hub to create an interference fit between the spider bushing and the spider hub.

The spider bushing must be rigidly installed in the central spider hub for the crusher to operate properly, which requires very precise machining of both the tapered OD on the spider bushing and the tapered ID within the spider hub. This precise machining increases the production costs of both components.

Over time, it is not uncommon for the tapered inner surface within the spider hub to wear, which results in the loss of the interference fit between the spider bushing and the spider hub. As a result of the loss of interference fit, the spider bushing will move within the hub, resulting in breakage of the retaining bolts that hold the spider bushing in place. If the spider bushing is not held rigidly in place, seizure of the eccentric bushing in the lower end of the crusher will eventually occur because of the misalignment that is created within the lower eccentric bushing. In order to prevent this problem, the spider bushing must be removed and either replaced with an oversized spider bushing to recreate the interference fit or the inner bore formed within the spider hub must be re-machined. In either case, a significant expense and extended downtime of the gyratory crusher result.

### SUMMARY

The present disclosure relates to a gyratory crusher for use in breaking rock, stone or other materials in a crushing cavity. The gyratory crusher includes a spider positioned near the top end of the gyratory crusher. The spider includes a central hub having an internal bore and a bushing support shoulder. A mainshaft of the gyratory crusher is mounted such that an upper end of the mainshaft is supported within the central hub of the spider. Specifically, a spider bushing surrounds the upper end of the main shaft to support the upper end of the main shaft. The spider bushing is positioned within the internal bore of the central hub of the spider. The spider bushing includes a main body and an outer flange that extends radially from the main body.

The main body of the spider bushing includes an outer surface that decreases in outer diameter from an upper end to a lower end. The internal bore formed within the central hub of the spider includes a tapered inner surface that has a decreasing inner diameter from an upper end to a lower end of the internal bore. The tapered outer surface of the spider bushing and the tapered inner surface of the internal bore formed within the spider create an interference fit between the spider bushing and the internal bore of the spider.

In accordance with the present disclosure, an adjustment means is used to adjust the spacing between a bushing support shoulder of the spider and the outer flange of the spider bushing. The use of the adjustment means allows the interference fit created between the spider and the spider bushing to be modified upon wear to either the spider bushing or the spider.

In one embodiment of the disclosure, the adjustment means is one or more shims that are positioned between the bushing support shoulder of the spider and the outer flange of the spider bushing. The one or more shims are positioned between the bushing support shoulder and the outer flange of the spider bushing to create a desired gap between the bushing support shoulder and the outer flange of the spider bushing. Once the shims are in position, the spider and the spider bushing can be connected to each other utilizing a series of spaced connectors.

Upon wear to either the spider or the spider bushing, one or more of the shims can be removed such that the spider bushing can move further downward into the spider. The movement of the spider bushing into the spider improves the interference fit between the spider bushing and the spider upon wear to either of the components.

In another embodiment of the disclosure, the adjustment means is either a series of individual washers or support bolts that can be adjusted to define the desired gap between the spider and the spider bushing.

Various other features, objects and advantages of the invention will be made apparent from the following description taken together with the drawings.

### BRIEF DESCRIPTION OF THE DRAWINGS

The drawings illustrate the best mode presently contemplated of carrying out the disclosure. In the drawings:

FIG. 1 is a section view of an upper portion of a gyratory crusher utilizing the system and method of the present disclosure;

FIG. 2 is a magnified view showing the position of the spider bushing within the central hub of the spider;

FIG. 3 is an exploded view showing the spider bushing, central hub of the spider, and a shim;

FIG. 4 is a magnified view of the spacing between the outer flange of the spider bushing and the bushing support shoulder of the central hub;

FIG. 5 is a magnified view showing the position of one or more shims between the outer flange and the bushing support shoulder;

FIG. 6 is a perspective view showing the position of one or more shims below the outer flange of the spider bushing;

FIG. 7 is a top view of one embodiment of the shim;

FIG. 8 is a magnified view showing a first alternate embodiment of the means for adjusting the interference fit between the outer flange of the spider bushing and the bushing support shoulder of the central hub; and

FIG. 9 is a magnified view showing a second alternate embodiment of the means for adjusting the interference fit between the outer flange of the spider bushing and the bushing support shoulder of the central hub.

### DETAILED DESCRIPTION

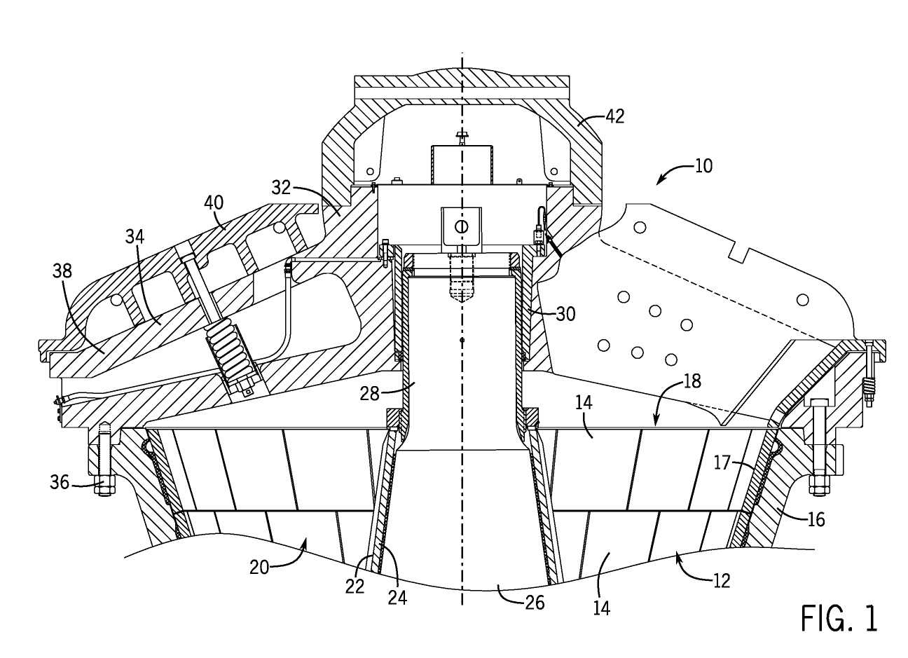

FIG. 1 illustrates an upper portion of a gyratory crusher 10, where the lower portion is well known in the prior art and thus not shown. The gyratory crusher 10 includes an shell 12 that includes multiple rows of concaves 14 positioned along the inner surface of an upper top shell casting 16 to define a generally tapered frustoconical inner surface 17 that directs material from an open top end 18 downward through a converging crushing cavity 20 formed between the inner surface 17 defined by the rows of concaves 14 and an outer surface 22 of a frustoconical mantle 24 positioned on a gyrating main shaft 26. Material is crushed over the height of the crushing cavity 20 between the inner surface 17 of the shell 12 and the outer surface 22 of the mantle 24 as the mainshaft 26 gyrates.

The upper end 28 of the mainshaft 26 is supported in a spider bushing 30 contained within a central hub 32 of a spider 34. The spider 34 is mounted to the upper top shell 16 by a series of bolts 36. The spider 34 includes a plurality of spider arms 38 that support the central hub 32 in the position as shown. In the embodiment illustrated, spider arm shields 40 are mounted to each of the spider arms 38 to provide wear protection. A spider cap 42 mounts over the central hub 32 to provide additional wear protection for the central hub 32.

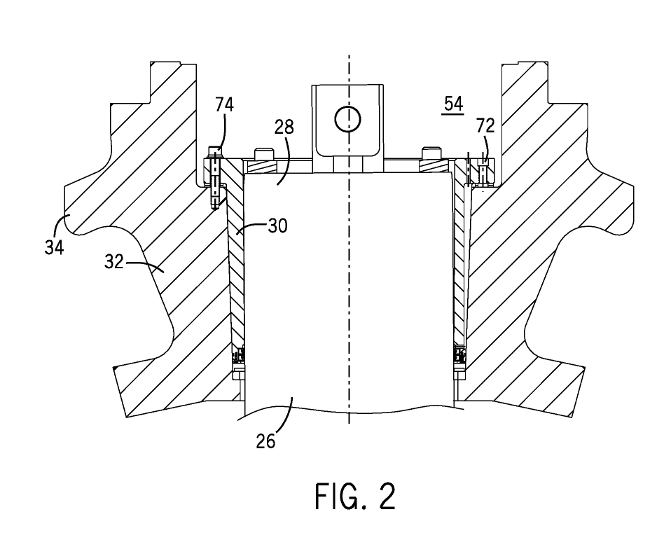

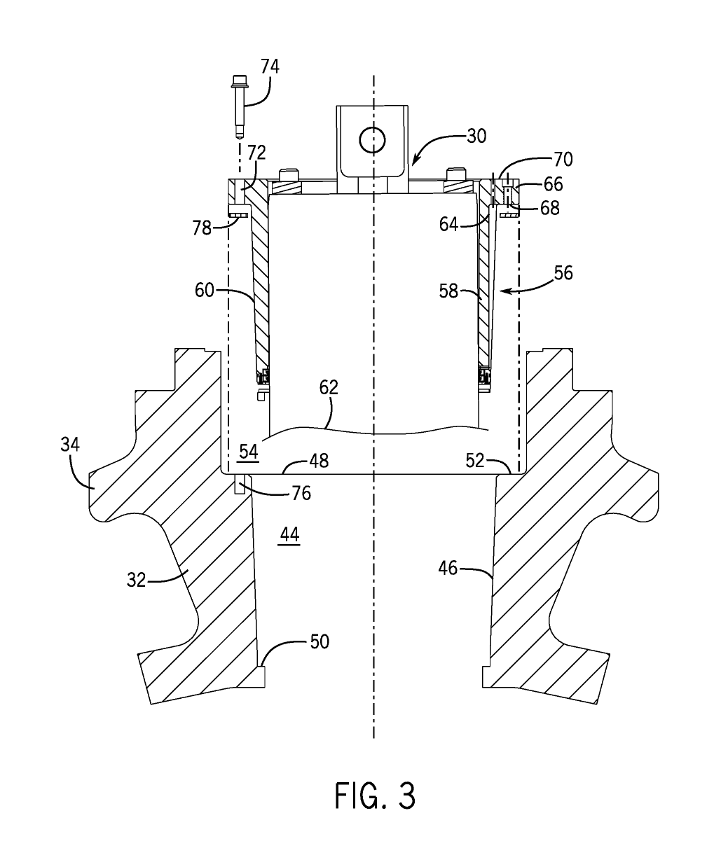

FIG. 2 is a magnified view of the position of the upper end of the mainshaft 26 within the central hub 32 of the spider 34. As illustrated in FIG. 2, the spider bushing 30 surrounds the upper end 28 of the mainshaft 26. The spider bushing 30 is received within an internal bore 44 formed in the central hub 32, as best illustrated in the exploded view of FIG. 3. In the embodiment shown in FIG. 3, the internal bore 44 is defined by a tapered inner surface 46 that includes an inner diameter (ID) that decreases from an upper end 48 to a lower end 50. In the embodiment illustrated, the taper of the internal bore 44 is defined by a decreasing ID from the upper end 48 to the lower end 50 such that the diameter decreases on the order of 0.006 inches.

An access area 54 is positioned slightly above the internal bore 44. The access area 54 allows tooling and other components to access the upper end 28 of the mainshaft 26 when the spider bushing 30 is installed, as can be understood in FIG. 2.

Referring again to FIG. 3, the spider bushing 30 is a one piece member that includes a main body 56 that is defined by an annular wall 58. The annular wall 58 defines an outer surface 60 that extends from a lower end 62 to an upper end 64. The outer surface 60 is tapered and thus has an outer diameter (OD) that decreases from the upper end 64 to the lower end 62. The tapered outer surface 60 of the spider bushing 30 creates an interference fit with the tapered inner surface 46 of the central hub 32 when the spider bushing 30 is installed in the central hub 32 as shown in FIG. 2.

The upper end 64 is located below an outer flange 66 that protrudes radially outward from the outer surface 60 of the annular wall 58. The flange 66 has a lower contact surface 68 and an annular top surface 70. As illustrated in FIG. 3, a plurality of bores 72 extend through the outer flange 66 and each are sized to receive a connector 74. As illustrated in FIG. 2, the connectors 74 are used to securely attach the spider bushing 30 to the central hub 32 in a manner to be discussed below. As illustrated in FIG. 3, the central hub 32 includes a plurality of spaced bores 76 that are sized to receive the threaded shaft portion of each of the connectors 74.

In the embodiment shown in FIG. 3, the outer diameter of the body 56 of the spider bushing 30, which is defined by the outer surface 60, is tapered from the upper end 64 to the lower end 62. Thus, when the spider bushing 30 is installed into the central hub 32 of the spider, the tapered outer surface 60 of the spider bushing creates an interference fit with the tapered inner surface 46 of the bore 44 of the central hub 32.

Since both the outer surface 60 of the spider bushing 30 and the inner surface 46 of the bore 44 wear during operation of the gyratory crusher and the cost and effort to maintain the tight machining tolerances is high, the present disclosure includes a means for adjusting the interference fit between the spider bushing 30 and the internal bore 44. The use of the adjustment means allows for a slight relaxation of the machining tolerances on the tapered surfaces, which simplifies the manufacturing process and may lead to a reduction in the cost of the parts.

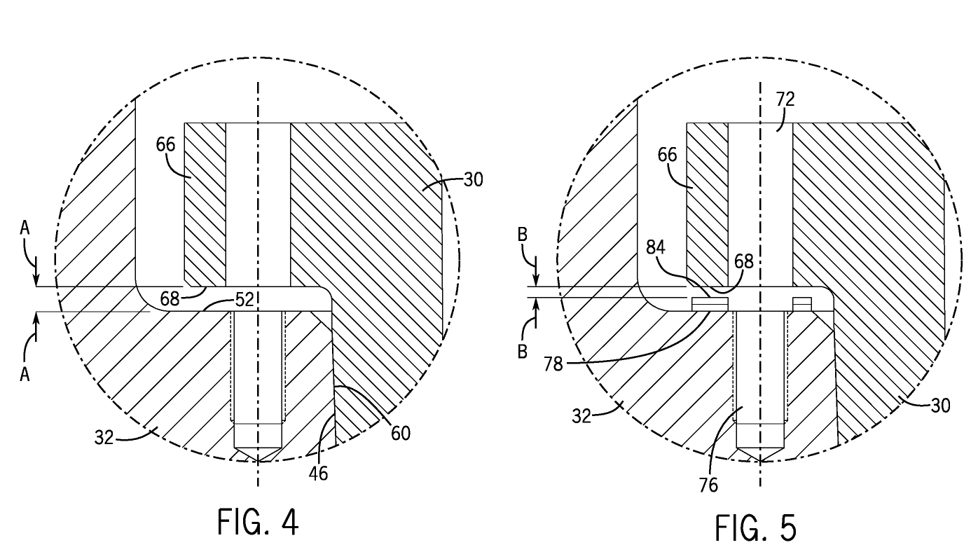

In order to accommodate the interference fit adjustment means, the spider bushing 30 is machined such that the tapered outer diameter defined by the outer surface 60 is slightly greater than the inner diameter of the internal bore 44 defined by the inner surface 46. When the spider bushing is initially installed in the internal bore, the interference fit between the two components creates a gap A-A shown in FIG. 4 between the bushing support shoulder 52 and the outer flange 66 of the spider bushing 30. As the components begin to wear, in order to maintain the interference fit, the spider bushing 30 will need to move further downward into the internal bore 44. As a result of this movement, the gap A-A will be reduced. As stated, the interference fit adjustment means of the present disclosure will allow for compensation for this wear and will thus reduce the requirement for very precise machining of the tapered surfaces of the spider bushing 30 and the internal bore 44.

In one embodiment of the disclosure, the means for adjusting the interference fit between the bushing support shoulder 52 and the outer flange 66 of the spider bushing 30 takes the form of one or more annular shims 78, which is shown in FIG. 3. Although an annular shim 78 is shown, different types of components are contemplated as being operable to adjust the distance between the bushing support shoulder of the spider and the outer flange of the spider bushing, as will be described in much greater detail below.

Referring now to FIG. 4, during the initial assembly of the gyratory crusher, the spider bushing 30 is lowered into the internal bore 44 until the tapered outer surface 60 of the spider bushing 30 engages the tapered inner surface 46 of the central hub 32. Since the outer diameter of the spider bushing 30 is machined to be larger than the inner diameter of the internal bore of the central hub, upon this initial engagement, the lower contact surface 68 formed as part of the outer flange 66 of the spider bushing 30 will be spaced from the bushing support shoulder 52 by an initial gap 79 having a height illustrated by reference characters A-A in FIG. 4. This initial gap 79 is present only during the initial installation of the spider bushing 30 within the central hub 32 before any wear occurs between these two components. Since the size of the gap between the two components will decrease during the wearing of the tapered surfaces formed on the spider bushing 30 and the central hub 32, an adjustment device is used to support the spider bushing 30 within the central hub 32 while allowing each of the individual connectors 74 shown in FIG. 2 to be tightened to securely attach the spider bushing 30 in place.

In a first embodiment of the disclosure, the adjustment means is comprised of one or more annular shims 78, which are illustrated in FIGS. 5-7. The individual shims 78 include connector openings 86 that each surrounds one of the bores 76 formed in the spider 34. The connectors pass through the bore 72 formed in the attachment flange 66 and are received within the bore 76 formed in the central hub 32.

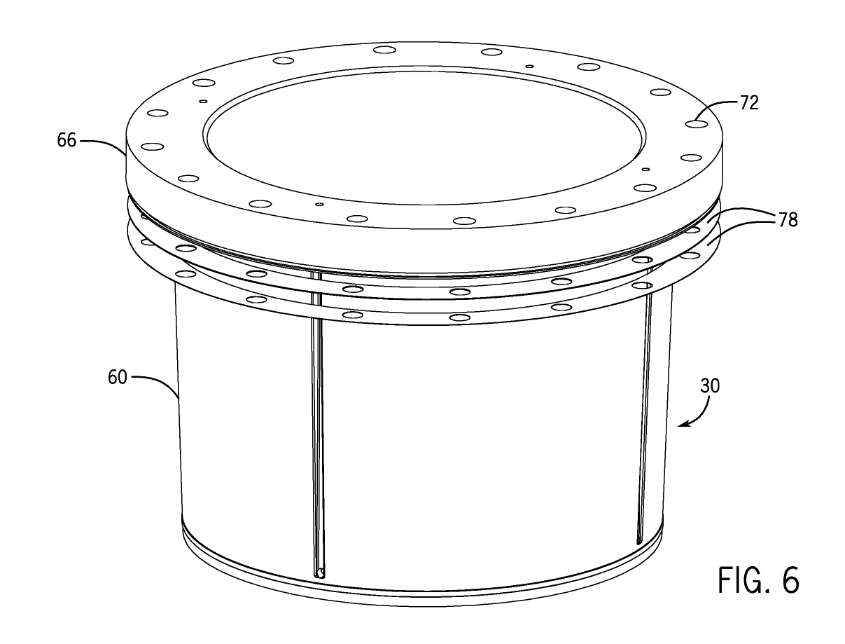

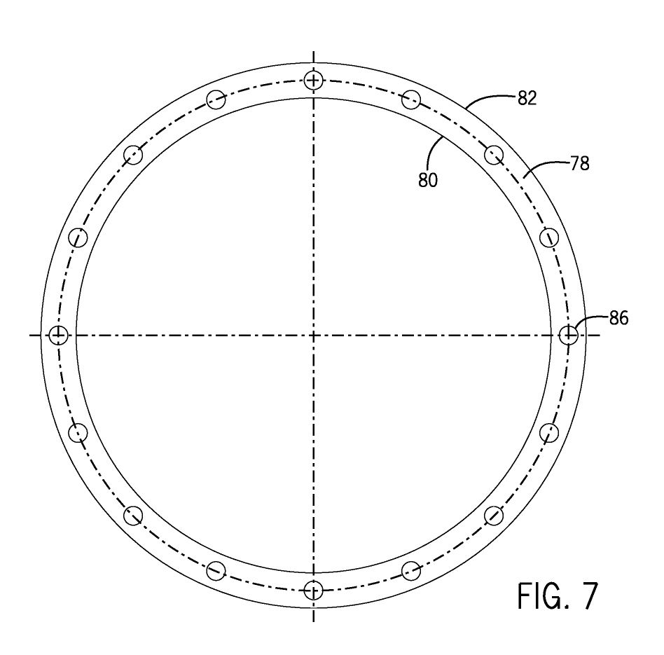

As illustrated in FIGS. 6 and 7, one or more shims 78 can be used depending on the size of the initial gap between the spider bushing and the central hub. Each of the individual shims 78 includes an inner surface 80 and an outer surface 82 that defines the radial width of the shim 78. Each of the shims 78 has a thickness, which can vary. It is contemplated that multiple shims could be used where the shims have different thickness. In one embodiment of the disclosure, the shims can have different thicknesses such as 0.025 inches, 0.050 or 0.010 inches. Combinations of these three shim thicknesses can be utilized to take up as much of the initial gap 79 shown in FIG. 4 such that a resulting gap 83, shown by reference characters B-B, exists between the top surface 84 of the stack of one or more shims 78 and the lower contact surface 68 of the outer flange 66. It is contemplated that the desired resulting gap 83 is in the range of 0.06-0.10 inches.

Referring back to FIG. 7, the shim 78 includes a series of connector openings 86 that allow the connectors 74 to pass through the individual shim 78, as illustrated in FIG. 2.

Once the shims have been positioned as shown in FIG. 5, the spider bushing 30 is lowered into position within the bore of the spider hub. Once in position, the individual connectors 74 are tightened to securely hold the spider bushing within the spider hub.

As the gyratory crusher operates and the outer surface of the spider bushing and the inner surface of the internal bore formed within the central hub begin to wear, the interference fit between the two components will begin to it will begin to lessen. When this happens, it will become necessary to modify the adjustment means to improve the interference fit. This can be done by first removing the spider bushing 30 from the spider. Once the spider bushing 30 is removed, one or more of the individual shims can be removed from between the spider bushing and the central hub. Once the shims are removed, the spider bushing 30 is again lowered into the internal bore. Since the shims 78 shown in FIG. 5 are no longer present, the spider bushing 30 can be lowered further into the bore, which again creates the interference fit between the tapered outer surface of the spider bushing and the tapered inner surface of the internal bore. This process can be repeated several times by continually adjusting the adjustment means.

As described above, in one embodiment of the disclosure, the means for adjusting the interference fit between the bushing support shoulder and the outer flange of the spider bushing is created through the use of one or more individual shims. However, it is contemplated that other types of devices or components could be utilized while operating within the scope of the present disclosure.

FIG. 8 illustrates a first, alternate contemplated embodiment for the means for adjusting the interference fit. In this embodiment, a series of set screws 90 are received in internally threaded bores 92 formed in the outer flange 66 of the spider bushing 30. The position of the set screw 90 within the threaded bore can be adjusted by rotating the set screw 90. The bottom end 94 of the set screw 90 contacts the bushing support shoulder 52. A lock nut 96 can be used to secure the position of the set screw 90 as illustrated.

As the spider bushing 30 and central hub 32 begin to wear, the set screw 90 can be rotated to adjust the amount the bottom 94 extends past the lower contact surface 68, as illustrated by the arrow in FIG. 8.

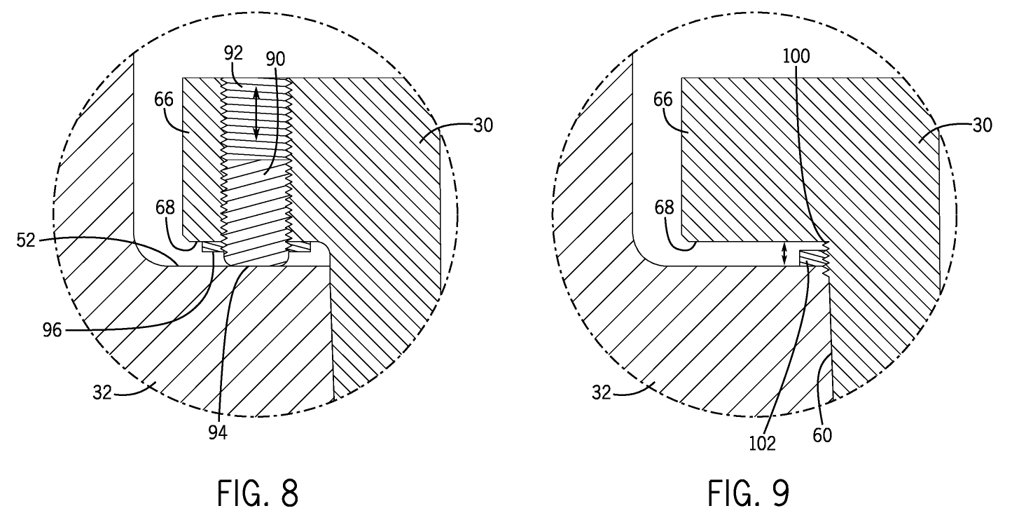

FIG. 9 illustrates a second, alternate contemplated embodiment for adjusting the interference fit. In this embodiment, the outer surface 60 of the spider bushing 30 includes a series of external threads 100. The external threads 100 extend along only a portion of the outer surface 60 near the outer flange 66. The external threads 100 received internal threads formed on an adjustment nut 102. The position of the adjustment nut 102 along the outer surface of the spider bushing 30 can be adjusted vertically by rotation of the adjustment nut 102 relative to the spider bushing, as illustrated by the arrow in FIG. 9. The adjustment nut 102 contacts the bushing support shoulder 52.

As the spider bushing 30 and central hub 32 begin to wear, the adjustment nut 102 can be rotated to adjust the vertical position of the adjustment nut 102 along the spider bushing. In this manner, the adjustment nut 102 can improve the interference fit between the spider bushing and the inner bore of the spider.

In yet another contemplated alternative, individual washers could be utilized surrounding each of the connectors 74 rather than the annular shim shown in FIG. 7.

Various other different types of devices and mechanisms could also be utilized while operating within the scope of the present disclosure. In each case, the adjustment device would create the desired spacing between the outer flange 66 of the spider bushing and the bushing support shoulder formed within the central hub. During wear, this adjustment device could be modified to begin to decrease the spacing between the outer flange of the spider bushing and the bushing support shoulder.

We claim:

1. A gyratory crusher, comprising:
a spider having a central hub including an internal bore and a bushing support shoulder;
a mainshaft having an upper end supported within the central hub of the spider;
a spider bushing positioned between the upper end of the mainshaft and the internal bore of the spider, the spider bushing having an outer flange; and
means for adjusting the spacing between the bushing support shoulder and the outer flange of the spider bushing, wherein the means for adjusting is operable to adjust the position of the spider bushing relative to the internal bore upon wear to the spider bushing or the spider.

2. The gyratory crusher of claim 1 wherein the means for adjusting is one or more shims positioned between the bushing support shoulder of the spider and the outer flange of the spider bushing.

3. The gyratory crusher of claim 2 wherein the means for adjusting includes a plurality of shims.

4. The gyratory crusher of claim 2 wherein each of the shims includes an annular body that surrounds the body of the spider bushing and has a thickness.

5. The gyratory crusher of claim 1 wherein the internal bore is tapered and the spider bushing includes a body having an outer surface, wherein the outer surface is tapered.

6. The gyratory crusher of claim 5 wherein the outer diameter of the outer surface of the spider bushing is greater than the inner diameter of the internal bore of the spider to create an interference fit.

7. The gyratory crusher of claim 1 wherein the means for adjusting is a series of set screws movable within the outer flange of the spider bushing.

8. The gyratory crusher of claim 1 wherein the means for adjusting is an adjustment nut received along an outer surface of the spider bushing, wherein rotation of the adjustment nut moves the adjustment nut along the outer surface of the spider bushing.

9. The gyratory crusher of claim 1 wherein the means for adjusting is a series of washers positioned between the bushing support shoulder of the spider and the outer flange of the spider bushing.

10. A gyratory crusher, comprising:
a spider having a central hub including a tapered internal bore and a bushing support shoulder;
a mainshaft having an upper end supported within the central hub of the spider;
a spider bushing positioned between the upper end of the mainshaft and the internal bore of the spider, the spider bushing having a body having a tapered outer surface and an outer flange extending from the outer surface; and
one or more shims positioned between the bushing support shoulder and the outer flange of the spider bushing, wherein the one or more shims are selectively removable to adjust the position of the spider bushing relative to the internal bore upon wear to the spider bushing or wear to the internal bore of the spider.

11. The gyratory crusher of claim 10 wherein each of the shims includes an annular body that surrounds the body of the spider bushing and has a thickness.

12. The gyratory crusher of claim 11 further comprising a plurality of shims each having a different thicknesses.

13. The gyratory crusher of claim 10 wherein the outer diameter of the outer surface of the spider bushing is greater than the inner diameter of the internal bore of the spider to create an interference fit.

14. A spider bushing assembly for use with a gyratory crusher having a spider including a central hub having a tapered internal bore and a bushing support shoulder, the assembly comprising:
a spider bushing having a body including a tapered outer surface and an outer flange extending from the outer surface; and
one or more shims positioned between the bushing support shoulder and the outer flange of the spider bushing, wherein the one or more shims are selectively removable to adjust the position of the spider bushing relative to the internal bore upon wear to the spider bushing.

15. The spider bushing assembly of claim 14 wherein each of the shims includes an annular body that surrounds the body of the spider bushing and has a thickness.

16. The gyratory crusher of claim 15 further comprising a plurality of shims each having a different thicknesses.

17. A method of adjusting the position of a spider bushing within a spider of a gyratory crusher including a mainshaft, the method comprising the steps of:
lowering the spider bushing into the spider until a tapered outer surface of the spider bushing contacts a tapered inner bore of the spider;
determining an initial gap between an outer flange of the spider bushing and a support shoulder within the spider;
removing the spider bushing from the spider;
installing one or more shims within the spider based upon the determined gap;
lowering the spider bushing into the spider such that the one or more shims are positioned between the outer flange of the spider bushing and the support shoulder of the spider; and
securing the spider bushing to the spider.

18. The method of claim 17 wherein the one or more shims are installed to create a desired gap between the one or more shims and the outer flange of the spider bushing.

19. The method of 17 further comprising the step of providing a plurality of shims having a plurality of thicknesses, wherein one or more shims are installed to reduce the determined gap to the desired gap.
